(19) United States
(12) Patent Application Publication
(10) Pub. No.: US 2013/0266854 A1
(43) Pub. Date: Oct. 10, 2013

(54) ELECTRODE FOR Li SECONDARY BATTERY, METHOD FOR PRODUCING THE SAME AND Li SECONDARY BATTERY

(71) Applicant: GWANGJU INSTITUTE OF SCIENCE AND TECHNOLOGY, Gwangju (KR)

(72) Inventors: Won-Bae Kim, Gwangju (KR); Sang-Hoon Nam, Gwangju (KR)

(73) Assignee: GWANGJU INSTITUTE OF SCIENCE AND TECHNOLOGY, Gwangju (KR)

(21) Appl. No.: 13/851,485

(22) Filed: Mar. 27, 2013

Related U.S. Application Data
(60) Provisional application No. 61/619,953, filed on Apr. 4, 2012.

(51) Int. Cl. H01M 4/134; H01M 4/04; H01B 5/00

(52) U.S. Cl. CPC H01M 4/134; H01B 5/00; H01M 4/0471
USPC 429/207; 174/126.1; 427/458

(57) ABSTRACT

An electrode for a lithium secondary battery is provided. A metal nanofiber has a network structure. A metal thin film or a metal oxide thin film includes the metal nanofiber. According to the electrode improves a charge migration performance.

### CROSS-REFERENCE TO RELATED APPLICATION

This application claims the benefit under 35 U.S.C. §119 of U.S. Patent Application No. 61/619,953, filed Apr. 4, 2012, which is hereby incorporated by reference in its entirety.

### BACKGROUND

The present disclosure relates to an electrode for a lithium secondary battery, and more particularly, to an electrode for a lithium secondary battery, including a Cu nanofiber-networked cobalt oxide thin film.

A Lithium secondary battery is one of secondary batteries, in which lithium ions transfer from a negative electrode to a positive electrode during discharging. During charging, the lithium ions transfer from the positive electrode to return to the negative electrode. The lithium secondary batteries have a high energy density, have no memory effect and have a small natural discharging degree when not in use. Thus, the lithium secondary batteries are widely used in portable electronic devices available.

Lithium ion batteries mainly include three parts of a positive electrode, a negative electrode and an electrolyte, and may use diverse materials. The most widely and commercially used material in the negative electrode is graphite. Graphite has a theoretical discharge capacity of 370 mAh/g. Researches on developing commercial negative electrode active material having higher capacity are under progress. For example, due to the theoretical capacity (780 to 890 mAh/g) corresponding to two times or three times of that of graphite, cobalt oxides are next generation negative electrode materials receiving attention.

However, the cobalt oxides have a low reversible capacity inferior to the theoretical capacity due to a high initial irreversible capacity, a low conductivity and the like. In addition, the cycle properties of the cobalt oxides are inferior to those required at a commercialization step.

In addition, the volume expansion of about 300% according to the Li-Co alloying may attribute to the crumbling of the electrode. Along with the decrease of the reversible capacity, the lifetime of an electrode may be decreased and the commercialization of the cobalt oxides may become difficult. Therefore, the development of a new cobalt oxide electrode structure solving the above-described defects is necessary.

### BRIEF SUMMARY

Embodiments provide an electrode for a lithium secondary battery improving the capacity and the performance of an electrode material, a method for producing the same and a lithium secondary battery including the same.

In one embodiment, an electrode for a lithium secondary battery includes: a metal nanofiber having a network structure; and a metal thin film or a metal oxide thin film including the metal nanofiber.

In another embodiment, a method for producing an electrode for a lithium secondary battery includes: preparing a polymer solution including a metal precursor; electrospinning the polymer solution on a substrate to form a metal/polymer nanofiber; heat treating the thus formed metal/polymer nanofiber to form a metal oxide nanofiber; reducing the thus formed metal oxide nanofiber to form a metal nanofiber; and forming a metal thin film or a metal oxide thin film on the substrate including the metal nanofiber formed on the substrate.

In further another embodiment a lithium secondary battery includes: a positive electrode; a negative electrode; and a lithium salt electrolyte electrically connecting the positive electrode and the negative electrode, at least one of the positive electrode and the negative electrode including a metal nanofiber having a network structure, and a metal thin film or a metal oxide thin film including the metal nanofiber.

According to embodiments as described above, an electrode for a lithium secondary battery including a cobalt oxide thin film containing a Cu nanofiber network improves a charge migration performance and induces the activation of lithium oxide produced during an electrochemical reaction, to obtain a high capacity and a high charge/discharge of the cobalt oxide used as the electrode material. In addition, the metal nanofiber network may function as a structure support and so, may illustrate a high capacity and decreases the crumbling phenomenon of the electrode.

The effects of the present disclosure may not be limited to the above-described effects. Other effects will be apparently understood by a person skilled in the art from the description below.

### BRIEF DESCRIPTION OF THE DRAWINGS

FIG. 1 is a SEM image of a Cu nanofiber network formed on a current collector.

FIG. 2 is a SEM image of a Cu nanofiber-networked cobalt oxide thin film electrode.

FIG. 3 is a graph illustrating a voltage curve of a cobalt oxide thin film electrode including a Cu nanofiber network and a cobalt oxide thin film electrode excluding a Cu nanofiber network.

FIG. 4 is a graph illustrating cycle properties of a cobalt oxide thin film electrode including a Cu nanofiber network and a cobalt oxide thin film electrode excluding a Cu nanofiber network.

FIG. 5 is a graph illustrating high rate charging/discharging properties of a cobalt oxide thin film electrode including a Cu nanofiber network and a cobalt oxide thin film electrode excluding a Cu nanofiber network.

FIG. 6 is a graph illustrating a differential capacity curve for the first cycle of a cobalt oxide thin film electrode including a Cu nanofiber network and a cobalt oxide thin film electrode excluding a Cu nanofiber network.

FIG. 7 is a graph illustrating a differential capacity curve for the tenth cycle of a cobalt oxide thin film electrode including a Cu nanofiber network and a cobalt oxide thin film electrode excluding a Cu nanofiber network.

FIG. 8 is a graph illustrating the measured result of an AC impedance of a cobalt oxide thin film electrode including a Cu nanofiber network and a cobalt oxide thin film electrode excluding a Cu nanofiber network.

FIG. 9 is an image illustrating the transformation of the electrode structure of a cobalt oxide thin film electrode excluding a Cu nanofiber network after finishing 30 cycles.

FIG. 10 is an image illustrating the transformation of the electrode structure of a cobalt oxide thin film electrode including a Cu nanofiber network after finishing 30 cycles.

### DETAILED DESCRIPTION

Reference will now be made in detail to the embodiments of the present disclosure, examples of which are illustrated in the accompanying drawings.

Embodiments on a method for producing an electrode for a lithium secondary battery including a cobalt oxide thin film containing a Cu nanofiber network and a method of manufacturing a lithium secondary battery including the electrode will be described.

A substrate is prepared. The substrate may be a material functioning as a current collector and a stainless steel substrate. However, the substrate is not limited to the stainless steel substrate. A polymer solution including a metal precursor is prepared. The metal precursor may include Cu, however, may not limited to this material.

The polymer solution may include polyvinylpyrrolidone, nylon 6, polyacrylonitrile, poly(ethylene oxide), poly(methyl methacrylate), polystyrene, polypropylene carbonate), poly(vinyl acetate), poly(vinyl alcohol), poly(vinylidene fluoride), poly(vinylidene fluoride-co-hexafluoropropylene) or polycarbomethylsilane, without limitation.

For example, the polymer solution including the metal precursor may be a mixture solution of CuCl₂.2H₂O, methanol and polyvinylpyrrolidone (PVP, Mw=1,300,000 g·mol⁻¹).

On the substrate, the polymer solution including the metal precursor is applied by using an electrospinning process to form a metal/polymer nanofiber.

For example, the polymer solution including the metal precursor, that is, the mixture solution of CuCl₂.2H₂O and PVP is loaded into a syringe having a 23-gauge stainless steel needle. The distance between a needle tip and the ground stainless steel substrate is 10 cm. An electric field of 10 kV is applied between the needle tip and the substrate to form a CuCl₂/PVP nanofiber on the substrate.

The thus formed metal/polymer nanofiber is heat treated to form a metal oxide nanofiber.

For example, the CuCl₂/PVP nanofiber is heat treated at about 300° C. for 3 hours in air to form a Cu oxide nanofiber.

The thus formed metal oxide nanofiber undergoes a reduction reaction to form a metal nanofiber having a network structure. The reduction reaction may be a hydrogenation process, without limitation.

For example, the Cu oxide nanofiber may be reduced at 200° C. under H₂ atmosphere at a flow rate of 60 sccm to form a Cu nanofiber having a network structure.

The average diameter of the metal nanofiber may be 10 nm to 100 nm.

The mass ratio of the metal nanofiber and the metal oxide may be from 1:1 to 1:2. For example, the mass ratio of the Cu nanofiber and the cobalt oxide may be about 2:3, without limitation.

When the weight of the metal nanofiber is relatively larger when compared with that of the metal oxide, the volume of the metal nanofiber noncontributing to the capacity of the electrode may be relatively enlarged to deteriorate the increasing efficiency of a reversible capacity.

A metal thin film or a metal oxide thin film may be formed on a substrate on which the metal nanofiber having the network structure is formed.

The metal thin film includes silicon (Si) or tin (Sn), and the metal oxide thin film may include cobalt oxide (CoOₓ), titanium oxide (TiO₂), tin oxide (SnO₂), zinc oxide (ZnO), copper oxide (CuO), vanadium oxide (VOₓ), molybdenum oxide (MoOₓ) or a mixture thereof. However, any thin films possibly functioning as an electrode may be included without limitation.

For example, a cobalt oxide thin film may be formed on the Cu nanofiber formed on the substrate via RF sputtering by using a cobalt oxide target under Ar gas atmosphere at a working pressure of 1×10⁻³ torr.

The metal nanofiber may be dispersed in the metal thin film or the metal oxide thin film by forming a metal thin film or a metal oxide thin film on the substrate including the metal nanofiber formed thereon.

As the metal nanofiber is dispersed uniformly in the metal thin film or the metal oxide thin film, a nano structure may be uniformly formed on the deposited thin film to maximize the increasing effect of an electrode capacity.

The deposition thickness of the metal oxide thin film may be controlled to 50 nm to 150 nm, without limitation.

When the deposition thickness of the metal oxide thin film exceeds 150 nm, the size of Li₂O phase described hereinafter may not be less than or equal to about 10 nm, and an electrochemical activation may not be induced. Thus, the increasing efficiency of irreversible capacity may be decreased.

Further, a lithium secondary battery including a positive electrode, a negative electrode and a lithium salt electrolyte disposed between the positive electrode and the negative electrode and may be manufactured. At least one of the positive electrode and the negative electrode may include a metal nanofiber having a network structure, and a metal thin film or a metal oxide thin film containing the metal nanofiber.

Hereinafter, preferred examples will be suggested to assist the understanding of the present disclosure. However, the following examples are referred to assist the understanding of the present disclosure and are not limited to the following examples.

### EXAMPLES

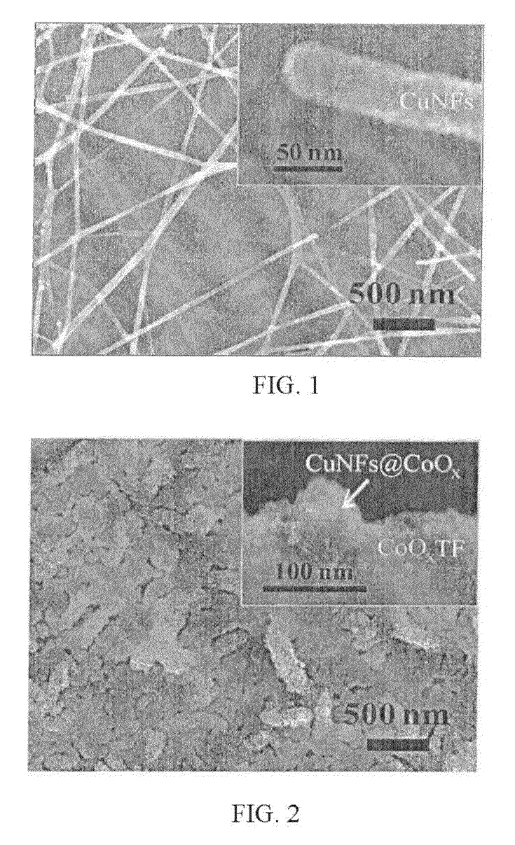

FIG. 1 is a SEM image of a Cu nanofiber network formed on a current collector.

Referring to FIG. 1, Cu nanofiber is deposited on a Si substrate to form an electrode. The average diameter of the Cu nanofiber is 30 nm to 70 nm.

FIG. 2 is a SEM image of a Cu nanofiber-networked cobalt oxide thin film electrode.

Referring to FIG. 2, the Cu nanofiber-networked cobalt oxide thin film has a rough surface due to the presence of the Cu nanofiber on the substrate. The surface of the cobalt oxide thin film is rough because the sputtered cobalt oxide is deposited on the surface of the Cu nanofiber as well as on the substrate. Accordingly, the contacting area between the electrolyte and the electrode material may be increased due to the rough surface, and the reversible capacity may be increased.

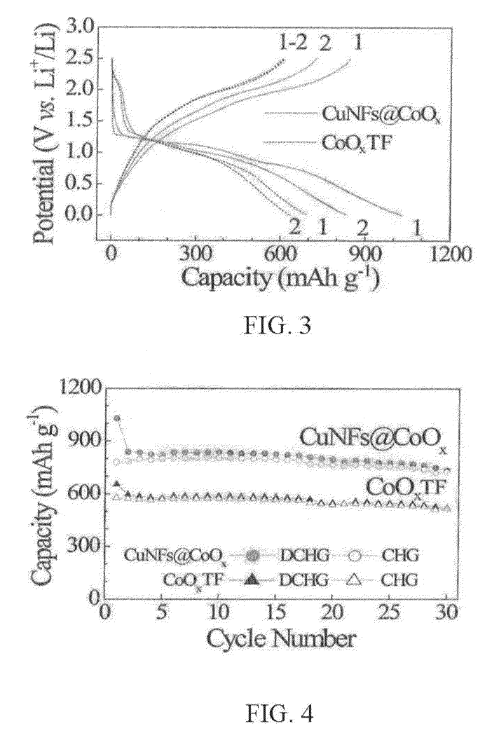

FIG. 3 is a graph illustrating a voltage curve of a cobalt oxide thin film electrode including a Cu nanofiber network and a cobalt oxide thin film electrode excluding a Cu nanofiber network.

Referring to FIG. 3, the first and second charging/discharging voltage may be observed between 2.5 V and 0.01 V. When the current density is 20 μA·cm⁻² (0.15C-rate), the cobalt oxide thin film electrode having the Cu nanofiber network may have a larger irreversible capacity by about 240 mAh·g⁻¹ when compared with the cobalt oxide thin film electrode excluding the Cu nanofiber network.

The result is obtainable because the contacting area of the electrolyte and the electrode material is increased due to the rough surface of the electrode material.

FIG. 4 is a graph illustrating cycle properties of a cobalt oxide thin film electrode including a Cu nanofiber network and a cobalt oxide thin film electrode excluding a Cu nanofiber network.

Referring to FIG. 4, the capacity value of the cobalt oxide thin film electrode including the Cu nanofiber network is higher by about 30% than that of the cobalt oxide thin film electrode excluding the Cu nanofiber network.

Since the cobalt oxide thin film electrode including the Cu nanofiber network forms a cobalt oxide thin film having a nano structure, the activation of lithium oxide represented by Chemical Reaction 1 described hereinafter may be induced. Accordingly, the relatively higher capacity value may be obtained.

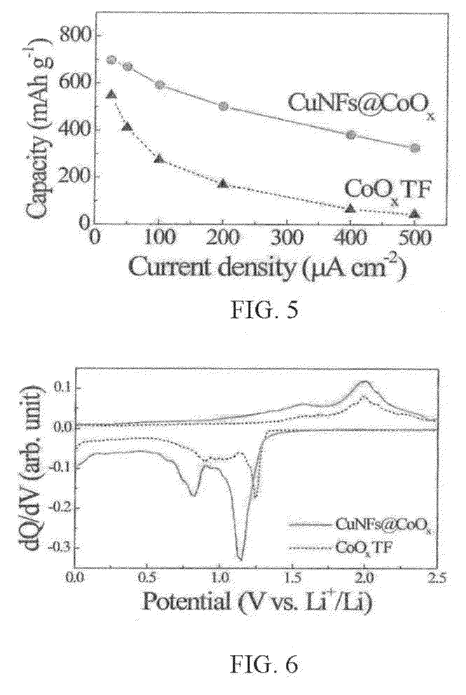

FIG. 5 is a graph illustrating high rate charging/discharging properties of a cobalt oxide thin film electrode including a Cu nanofiber network and a cobalt oxide thin film electrode excluding a Cu nanofiber network.

Referring to FIG. 5, the capacity of the cobalt oxide thin film electrode may be rapidly decreased as the increase of the current density. However, the decreasing rate of the capacity of the cobalt oxide thin film electrode including the Cu nanofiber network may be relatively small, and the capacity of about 400 mAh·g⁻¹, which is about 50% of an initial capacity, may be kept even when the current density is 500 μA·cm⁻² (3C-rate).

The electric conductivity may be improved since an effective electron transferring path is formed between a current collector and a negative electrode active material due to the Cu nanofiber network included in the cobalt oxide thin film.

FIG. 6 is a graph illustrating a differential capacity curve for the first cycle of a cobalt oxide thin film electrode including a Cu nanofiber network and a cobalt oxide thin film electrode excluding a Cu nanofiber network.

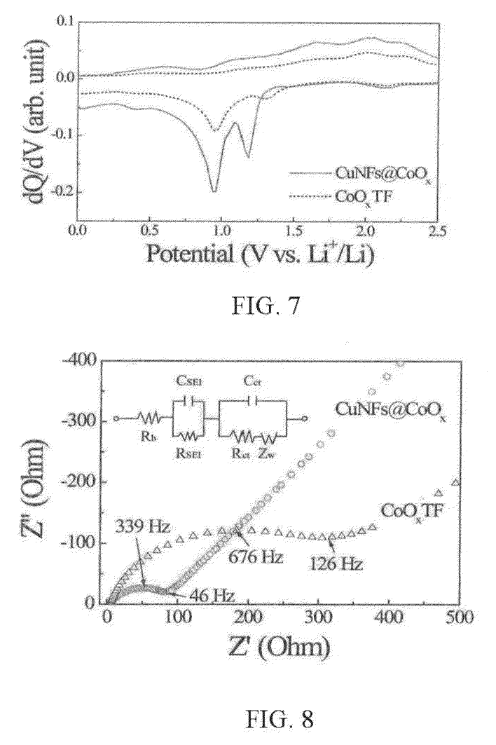

FIG. 7 is a graph illustrating a differential capacity curve for the tenth cycle of a cobalt oxide thin film electrode including a Cu nanofiber network and a cobalt oxide thin film electrode excluding a Cu nanofiber network.

Referring to FIG. 6, and from the differential capacity curve of the electrode at the first cycle, the cobalt oxide thin film electrode including the Cu nanofiber network has a relatively larger intensity and a higher capacity, and illustrates a faster reaction rate during phase transformation.

Referring to FIG. 7, the peak intensity and the integral area may be decreased at tenth cycle. This result may be obtained because of the generation of the irreversible capacity due to an incomplete electrochemical reaction.

Meanwhile, for the cobalt oxide thin film electrode having the Cu nanofiber network, the cathodic peak observed at 0.82 V and 1.15 V for the first cycle was observed respectively at 0.95 V and 1.18 V for the tenth cycle. The result means that the electrochemical reaction at the tenth cycle and the electrochemical reaction at the first cycle are different.

The following Chemical Reaction 1 represents electrochemical reactions while charging/discharging cobalt oxide thin film electrode having a Cu nanofiber network.

Co₃O₄+8Li⁻+8e⁻→4Li₂O+3Co (first discharge)

Co+Li₂O [symbol] CoO+2Li⁺2e⁻ (subsequent charge/discharge) Chemical Reaction 1

Referring to Chemical Reaction 1, the first discharge reaction is an irreversible reaction. Co₃O₄ and Li react to form Co and Li₂O. During the first discharge, Co and Li₂O forms CoO instead of Co₃O₄ owing to the similarity of oxygen lattice in Li₂O and CoO.

Then, in a subsequent charge/discharge, a modified oxygen lattice may be continuously preserved since the reaction of CoO with Li is a reversible reaction.

That is, the Li₂O phase formed in the first charge is electrochemically inactive. However, when the size of the thus formed Li₂O phase is less than or equal to about 10 nm, the Li₂O phase becomes electrochemically active. Then, a reversible reaction may occur in the subsequent charge/discharge process, and the result of a circulating voltage may be generated.

Therefore, a subsequent charge/discharge reversible reaction may contribute to the reversible capacity to illustrate a high capacity value.

FIG. 8 is a graph illustrating the measured result of an AC impedance of a cobalt oxide thin film electrode including a Cu nanofiber network and a cobalt oxide thin film electrode excluding a Cu nanofiber network.

Referring to FIG. 8, the sum of R_{SEI} and R_{ct} was measured at 344 Ω for the cobalt oxide thin film electrode excluding the Cu nanofiber network, and at 96 Ω for the cobalt oxide thin film electrode including the Cu nanofiber network.

The result illustrates an increased electric conductivity of a compound. This result illustrates that the Cu nanofiber network contributes to the high conductivity of the total electrode and improves the electrochemical properties of the cobalt oxide thin film during the cycle.

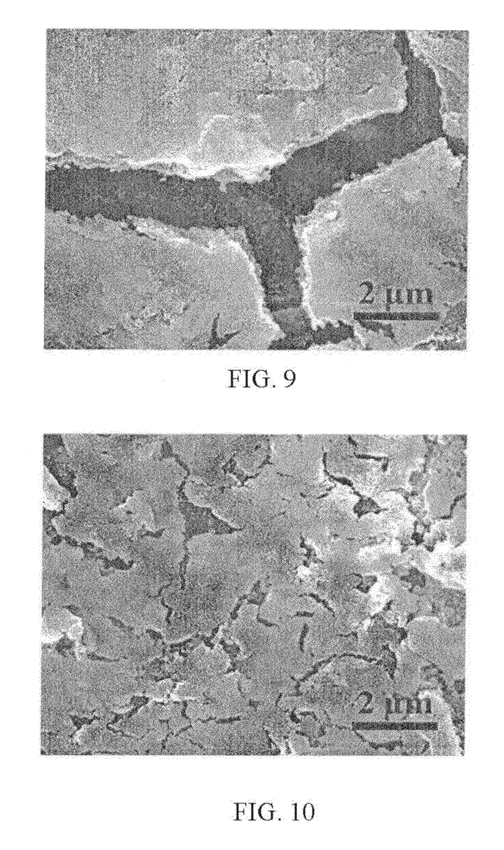

FIG. 9 is an image illustrating the transformation of the electrode structure of a cobalt oxide thin film electrode excluding a Cu nanofiber network after finishing 30 cycles.

FIG. 10 is an image illustrating the transformation of the electrode structure of a cobalt oxide thin film electrode including a Cu nanofiber network after finishing 30 cycles.

Referring to FIG. 9, the cobalt oxide thin film electrode after finishing 30 cycles illustrates serious cracking and crumbling phenomenon. On the contrary, referring to FIG. 10, the cobalt oxide compound electrode including the Cu nanofiber network illustrates a relatively stable state.

The Cu nanofiber network included in the cobalt oxide thin film electrode functions as a structure support and relaxes the stress on volume expansion. Thus, the cobalt oxide compound electrode including the Cu nanofiber network illustrates a high capacity and a decreased effect on a crumbling phenomenon.

Although embodiments have been described with reference to preferred embodiments thereof, it should be understood that numerous other modifications and embodiments can be devised by those skilled in the art that will fall within the spirit and scope of the principles of this disclosure.

What is claimed is:

1. An electrode for a lithium secondary battery comprising:
a metal nanofiber having a network structure; and
a metal thin film or a metal oxide thin film including the metal nanofiber.

2. The electrode according to claim 1, wherein the metal nanofiber is a Cu nanofiber.

3. The electrode according to claim 1, wherein the metal thin film comprises silicon or tin.

4. The electrode according to claim 1, wherein the metal oxide thin film comprises at least one of cobalt oxide, titanium oxide, tin oxide, zinc oxide, copper oxide, vanadium oxide, molybdenum oxide or a mixture including at least one of them.

5. The electrode according to claim 1, wherein a mass ratio of the metal nanofiber and the metal oxide is from 1:1 to 1:2.

6. A method for producing an electrode for a lithium secondary battery comprising:
preparing a polymer solution including a metal precursor;
electrospinning the polymer solution on a substrate to form a metal/polymer nanofiber;
heat treating the thus formed metal/polymer nanofiber to form a metal oxide nanofiber;
reducing the thus formed metal oxide nanofiber to form a metal nanofiber; and
forming a metal thin film or a metal oxide thin film on the substrate including the metal nanofiber formed on the substrate.

7. The method according to claim 6, wherein the metal precursor includes Cu.

8. The method according to claim 6, wherein the polymer solution includes polyvinylpyrrolidone, nylon 6, polyacrylonitrile, poly(ethylene oxide), poly(methyl methacrylate), polystyrene, polypropylene carbonate), poly(vinyl acetate), poly(vinyl alcohol), poly(vinylidene fluoride), poly(vinylidene fluoride-co-hexafluoropropylene) or polycarbomethylsilane.

9. The method according to claim 6, wherein the metal thin film comprises silicon or tin.

10. The method according to claim 6, wherein the metal oxide thin film comprises at least one of cobalt oxide, titanium oxide, tin oxide, zinc oxide, copper oxide, vanadium oxide, molybdenum oxide or a mixture thereof.

11. A lithium secondary battery comprising:
a positive electrode;
a negative electrode; and
a lithium salt electrolyte electrically connecting the positive electrode and the negative electrode,
at least one of the positive electrode and the negative electrode including a metal nanofiber having a network structure, and a metal thin film or a metal oxide thin film including the metal nanofiber.

12. The lithium secondary battery according to claim 11, wherein the metal nanofiber is a Cu nanofiber.

13. The lithium secondary battery according to claim 11, wherein the metal thin film comprises silicon or tin.

14. The lithium secondary battery according to claim 11, wherein the metal oxide thin film comprises at least one of cobalt oxide, titanium oxide, tin oxide, zinc oxide, copper oxide, vanadium oxide, molybdenum oxide or a mixture including at least one of them.

15. A lithium secondary battery according to claim 11, wherein a mass ratio of the metal nanofiber and the metal oxide is from 1:1 to 1:2.
